(19) United States
(12) Patent Application Publication
(10) Pub. No.: US 2016/0175860 A1
(43) Pub. Date: Jun. 23, 2016

(54) HIGH-SEAL ATOMIZING NOZZLE STRUCTURE WITH HIGH STABILITY

(71) Applicant: CHIH LUNG HSU, Taichung City (TW)

(72) Inventor: CHIH LUNG HSU, Taichung City (TW)

(21) Appl. No.: 14/572,824

(22) Filed: Dec. 17, 2014

(51) Int. Cl. B05B 7/04; B05B 15/06

(52) U.S. Cl. CPC B05B 7/0416; B05B 15/065

(57) ABSTRACT

A high-seal atomizing nozzle structure with high stability includes an assembly composed of a first body and a second body assembled together, and a rotor and a water stopping plug assembly mounted in the assembly. More particularly, a connection portion between the first body and the second body has an accommodating structure in which an anti-leakage ring is mounted. Thus, the anti-leakage ring may be hidden in the assembly to ensure the seal between the first body and the second body, and the breakage of the anti-leakage ring can be avoided. Also, a surface of the rotor has a plurality of parallel ribs each approaching an inner wall surface of the second body. So, when a liquid flows through the rotor, a lateral displacement and/or a skew condition of the rotor may be decreased, so that the atomizing effect of the atomizing nozzle has the high stability.

### BACKGROUND OF THE INVENTION

1. Field of the Invention

The invention relates to the technical field of an atomizing nozzle, and more particularly to an atomizing nozzle structure having a first body and a second body, which can be assembled together to form an atomizing nozzle structure with the high-seal and high stability atomizing effect.

2. Related Art

An atomizing nozzle may be composed of a first body and a second body assembled together to form an assembly through which a liquid may flow. In order to prevent the liquid from leaking, an anti-leakage ring (e.g., an O-ring) is typically disposed between an assembled position between the first body and the second body so as to achieve the anti-leakage and anti-penetration effects.

The anti-leakage ring is disposed between the first body and the second body so that a sandwich structure is formed. In order to make the anti-leakage ring have the better anti-leakage effect, the first body and the second body need to be further closed upon each other, so that the end surfaces of the first body and the second body can apply a suitable pressure to the anti-leakage ring to deform the anti-leakage ring.

Because the anti-leakage ring is interposed between two flat end surfaces, the end surface of the first body and the end surface of the second body do not completely press against each other. Thus, the assembled outlook is poor, and the anti-leakage ring may be exposed and tend to age and break so that the anti-leakage effect becomes deteriorated or failed in a short period of time.

Also, an ordinary atomizing nozzle assembly includes a body and a rotor assembled in a channel of the body, wherein the body has one end formed with an inlet, and the other end formed with a spray hole. When the liquid enters the body from the inlet and flows through a gap between the rotor and the channel and then sprayed out of the spray hole, the liquid can be micro-atomized.

Because the liquid has to flow through the gap between the rotor and the channel, the gap is about 0.15 mm or larger, so that the liquid can flow through the gap smoothly.

However, the gap width is sufficient to make the rotor generate the skew condition or lateral displacement in the channel. Thus, when the liquid flows through the gap and the rotor is in the unstable state, the atomizing effect may become unstable. More particularly, the rotor may be pushed against the wall surface of the channel, thereby biasing the liquid, and the liquid cannot uniformly flow through the periphery of the rotor. Consequently, the liquid finally sprayed out of the spray hole cannot be uniformly atomized.

### SUMMARY OF THE INVENTION

An object of the invention is to provide an atomizing nozzle structure with the high-seal and high stability atomizing effect, in which two members constituting the atomizing nozzle can effectively closely contact with each other to achieve the seal, and an anti-leakage ring between the two members can be hidden, so that the aging time of the anti-leakage ring can be lengthened, and the breakage of the anti-leakage ring can be avoided. In addition, the rotor can be lowered or the lateral displacement and/or skew condition can be avoided, so that the atomizing nozzle has the better use efficiency and the longer lifetime.

To achieve the above-identified object and effect, the invention discloses an atomizing nozzle comprising: a first body having one end formed with an atomizing end surface and the other end formed with a first connection end surface, wherein a spray hole is formed on the atomizing end surface, and a first channel connected to the spray hole is axially formed in the first body; a second body axially formed in a second channel, wherein the second body has one end formed with a second connection end surface, the second body is combined with the first body so that the first channel and the second channel communicate with each other, and the second connection end surface corresponds to the first connection end surface; a rotor disposed in a chamber formed by the first channel and the second channel communicating with each other, wherein a surface of the rotor has a plurality of parallel ribs, and a plurality of air passages are formed between the neighboring ribs, respectively, wherein a liquid can flow to the spray hole through the rotor and the air passages, the ribs approach an inner wall surface of the second channel, and in other words, an outer diameter of the ribs extremely approaches an inner diameter of the inner wall surface of the second channel; an accommodating structure disposed on the first connection end surface and the second connection end surface and comprising a first annular groove and a pressing shoulder; and an anti-leakage ring mounted in a first annular groove of the accommodating structure and pressed by the pressing shoulder.

In addition, the atomizing nozzle may also comprise: a first body having one end formed with an atomizing end surface and the other end formed with a first connection end surface, wherein a spray hole is formed on the atomizing end surface, and a first channel connected to the spray hole is axially formed in the first body; a second body axially formed in a second channel, wherein the second body has one end formed with a second connection end surface, the second body is combined with the first body so that the first channel and the second channel communicate with each other, and the second connection end surface corresponds to the first connection end surface; a rotor disposed in a chamber formed by the first channel and the second channel communicating with each other, wherein a surface of the rotor has a plurality of parallel ribs, and a plurality of air passages are formed between the neighboring ribs, respectively, wherein a liquid can flow to the spray hole through the rotor and the air passages, the ribs approach an inner wall surface of the second channel, and in other words, an outer diameter of the ribs extremely approaches an inner diameter of the inner wall surface of the second channel; an accommodating structure comprising a first annular groove formed on the first connection end surface of the first body and a second annular groove formed on the second connection end surface of the second body; and an anti-leakage ring mounted in a chamber formed by the first annular groove and the second annular groove facing each other.

The present invention will become more fully understood from the detailed description given hereinbelow and the accompanying drawings which are given by way of illustration only.

### BRIEF DESCRIPTION OF THE DRAWINGS

FIG. 1 is an exploded view showing a first embodiment of the invention.

FIG. 2 is a schematically assembled view showing the first embodiment of the invention.

FIG. 3 is a schematically assembled view showing a second embodiment of the invention.

FIG. 4 is a schematically assembled view showing a third embodiment of the invention.

### DETAILED DESCRIPTION OF THE INVENTION

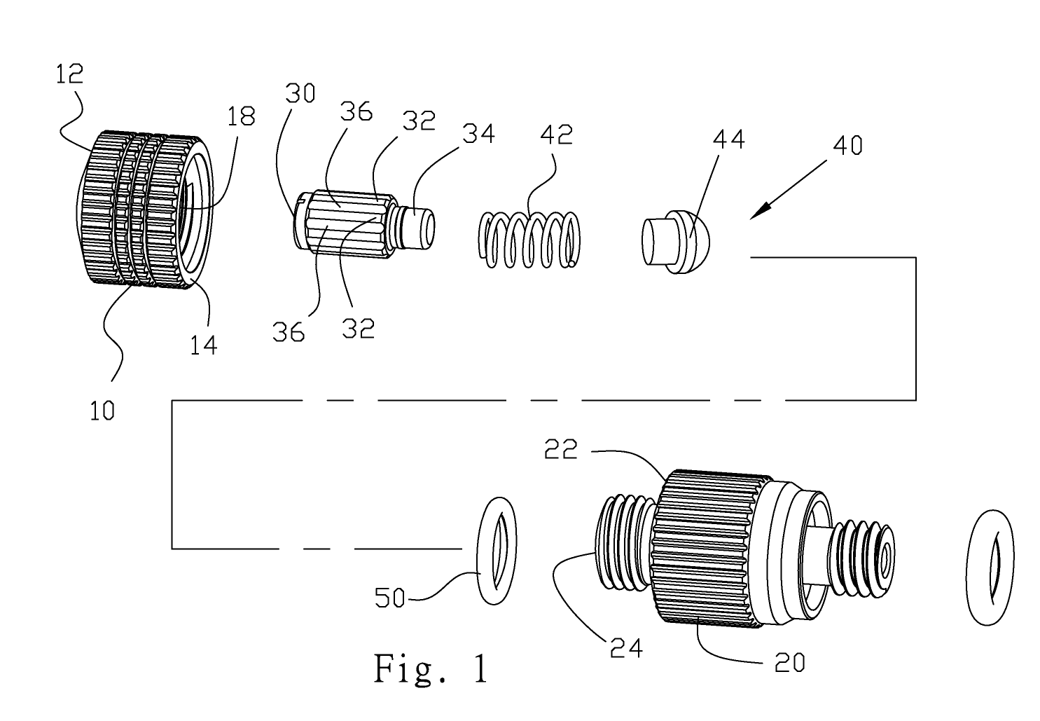

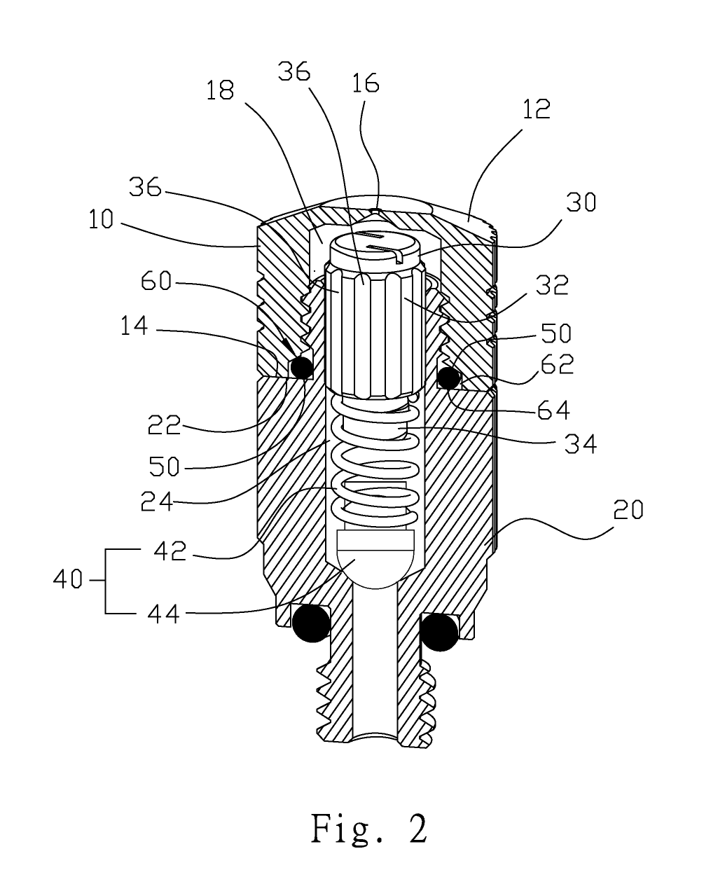

Referring to FIGS. 1 and 2, the atomizing nozzle includes a first body (10), a second body (20), a rotor (30) and a water stopping plug assembly (40). The first body (10) and the second body (20) may be combined together by way of screwing. The rotor (30) and the water stopping plug assembly (40) are mounted in the assembly of the first body (10) and the second body (20).

Furthermore, the first body (10) has one end formed with an atomizing end surface (12), and the other end formed with a first connection end surface (14). A spray hole (16) (see FIG. 2) is formed on the atomizing end surface (12), and the first body (10) is axially formed with a first channel (18) connected to the spray hole (16).

The second body (20) has one end formed with a second connection end surface (22), and is axially formed with a second channel (24). The second body (20) is combined with the first body (10) so that the first channel (18) and the second channel (24) communicate with each other, and the second connection end surface (22) corresponds to the first connection end surface (14).

The rotor (30) is disposed in the chamber (see FIG. 2) formed by the first channel (18) and the second channel (24) communicating with each other. Furthermore, the surface of the rotor (30) has a plurality of ribs (32), and neighboring two of the ribs (32) are parallel to each other. An air passage (36) is formed between two the neighboring ribs (32). In other words, the surface of the rotor (30) has a plurality of air passages (36), and the neighboring air passages (36) are parallel to each other. Also, the water stopping plug assembly (40) is composed of a spring (42) and a valve ball (44) and is disposed on one end of the rotor (30). Furthermore, the spring (42) is to be connected to a connection section (34) of the one end of the rotor (30). The valve ball (44) may have a semi-ball shape, a ball shape or any other shape. In addition, an anti-leakage ring (50) is disposed between the first body (10) and the second body (20).

Referring to FIG. 2, it is to be noted that an accommodating structure (60) for accommodating and positioning the anti-leakage ring (50) is disposed between the first body (10) and the second body (20). Furthermore, the accommodating structure (60) includes a first annular groove (62) and a pressing shoulder (64), wherein the first annular groove (62) is formed on the first connection end surface (14), and the pressing shoulder (64) is the second connection end surface (22). The anti-leakage ring (50) is accommodated within the first annular groove (62) and is pressed and positioned by the pressing shoulder (64).

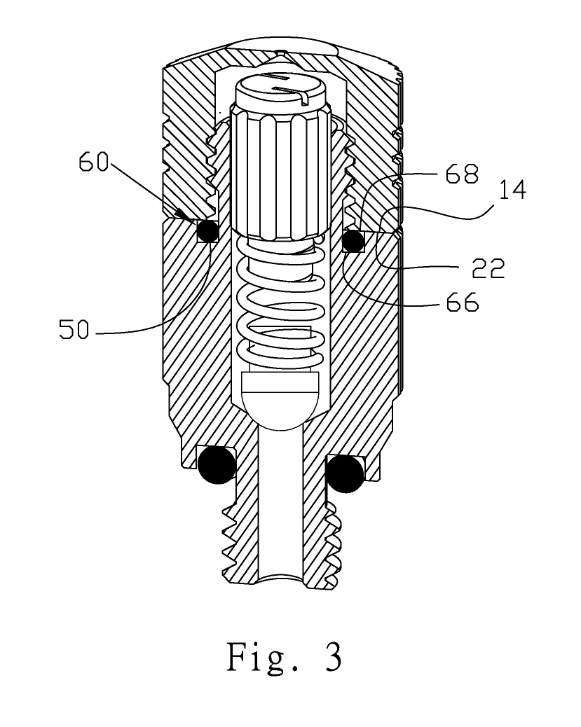

Referring to FIG. 3, the accommodating structure (60) includes a second annular groove (66) and a pressing shoulder (68), wherein the second annular groove (66) is formed on the second connection end surface (22), and the pressing shoulder (68) is the first connection end surface (14). The anti-leakage ring (50) is fit within the accommodating structure (60). Furthermore, the anti-leakage ring (50) is accommodated within the second annular groove (66) and is pressed and positioned by the pressing shoulder (68).

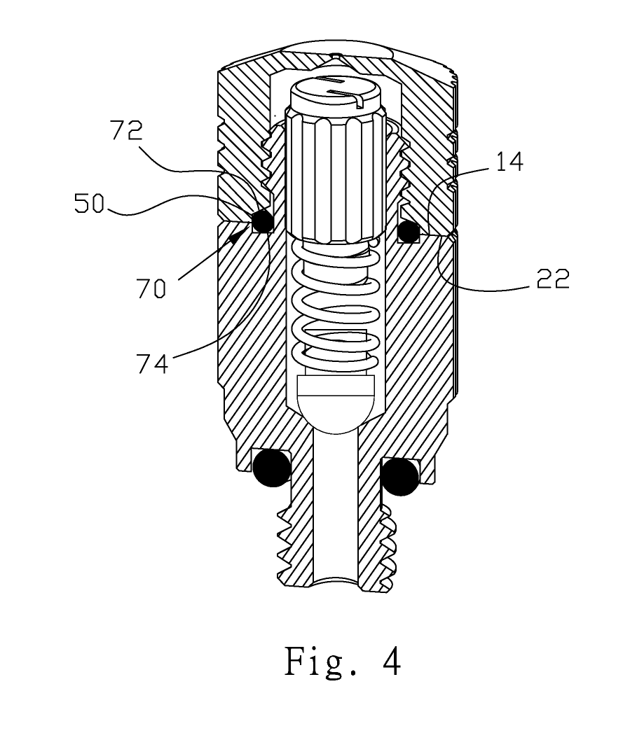

FIG. 4 shows an accommodating structure (70) of another embodiment. The accommodating structure (70) includes a first annular groove (72) and a second annular groove (74), wherein the first annular groove (72) is formed on the first connection end surface (14), and the second annular groove (74) is formed on the second connection end surface (22). The anti-leakage ring (50) is fit within the accommodating structure (70). Furthermore, a portion of the anti-leakage ring (50) is accommodated within the first annular groove (72), the other portion of the anti-leakage ring (50) is accommodated within the second annular groove (74), and the anti-leakage ring (50) is pressed by the bottom surfaces of the two annular grooves.

Each of the atomizing nozzles of FIGS. 3 and 4 has the rotor (30) and the water stopping plug assembly (40). The structures or assembling forms of the rotor (30) and the water stopping plug assembly (40) disclosed in FIGS. 3 and 4 are the same as those disclosed in FIGS. 1 and 2, so detailed descriptions thereof will be omitted.

As shown in FIGS. 2, 3 and 4, the anti-leakage ring (50) is accommodated within the accommodating structure (60) or (70). After the first body (10) and the second body (20) are assembled into the assembly, the anti-leakage ring (50) may be disposed in the assembly in a hidden manner. Thus, the anti-leakage ring (50) can achieve the anti-leakage effect on the assembly, and the unexposed anti-leakage ring (50) may also reduce the possibility of breakage.

The rotor (30) is disposed in the second channel (24), and a surface of the rotor (30) has a plurality of parallel ribs (32), wherein air passages (36) are formed between the neighboring ribs (32). Furthermore, with the above-mentioned structure, the rotor (30) approaches the inner wall surface of the second channel (24) through each rib (32). In other words, there is almost no gap formed between each rib (32) and the inner wall surface of the second channel (24). So, when the liquid flows through the rotor (30) via the air passage (36), the lateral displacement and/or skew condition of the rotor (30) can be avoided or reduced to the lowest one.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A high-seal atomizing nozzle structure with high stability, the high-seal atomizing nozzle structure atomizing a liquid and comprising:
a first body having one end formed with an atomizing end surface and the other end formed with a first connection end surface, wherein a spray hole is formed on the atomizing end surface, and a first channel connected to the spray hole is axially formed in the first body;
a second body axially formed in a second channel, wherein the second body has one end formed with a second connection end surface, the second body is combined with the first body so that the first channel and the second channel communicate with each other, and the second connection end surface corresponds to the first connection end surface; and
a rotor disposed in a chamber formed by the first channel and the second channel communicating with each other, wherein a surface of the rotor has a plurality of parallel ribs, and a plurality of air passages are formed between the neighboring ribs, respectively,
wherein the liquid flows through each of the air passages and is sprayed out of the spray hole, the rotor approaches a wall surface of the second channel through each of the ribs to reduce or avoid a lateral displacement and/or a skew condition.

2. The high-seal atomizing nozzle structure according to claim 1, further comprising a water stopping plug assembly, which is a combination of a spring and a valve ball, and disposed on one end of the rotor.

3. The high-seal atomizing nozzle structure according to claim 2, wherein the one end of the rotor has a connection section to be combined with the spring.

4. The high-seal atomizing nozzle structure according to claim 1, further comprising an accommodating structure and an anti-leakage ring, wherein the accommodating structure is formed on the first connection end surface and the second connection end surface, and the anti-leakage ring is mounted in a first annular groove of the accommodating structure, so that the first body and second body are accommodated within the accommodating structure in a highly sealed manner through the anti-leakage ring.

5. The high-seal atomizing nozzle structure according to claim 4, wherein the accommodating structure comprises the first annular groove and a pressing shoulder, the first annular groove is formed on the first connection end surface of the first body, and the pressing shoulder is the second connection end surface of the second body.

6. The high-seal atomizing nozzle structure according to claim 4, wherein the accommodating structure comprises a second annular groove and a pressing shoulder, the second annular groove is formed on the second connection end surface of the second body, and the pressing shoulder is the first connection end surface of the first body.

7. The high-seal atomizing nozzle structure according to claim 4, wherein the accommodating structure comprises the first annular groove and a second annular groove, the first annular groove is formed on the first connection end surface of the first body, and the second annular groove is formed on the second connection end surface of the second body.
